(19) United States
(12) Patent Application Publication
(10) Pub. No.: US 2023/0336418 A1
(43) Pub. Date: Oct. 19, 2023

(54) CARBON NEUTRALIZATION HANDLING IN A COMMUNICATION NETWORK

(71) Applicant: MEDIATEK INC., Hsinchu (TW)

(72) Inventors: Chien-Sheng YANG, Hsinchu (TW); Chien-Chun HUANG-FU, Hsinchu (TW); I-Kang FU, Hsinchu (TW)

(73) Assignee: MEDIATEK INC., Hsinchu (TW)

(21) Appl. No.: 18/183,578

(22) Filed: Mar. 14, 2023

Related U.S. Application Data
(60) Provisional application No. 63/331,345, filed on Apr. 15, 2022.

(51) Int. Cl. H04L 45/00; H04L 41/0833

(52) U.S. Cl. CPC H04L 41/0833; H04L 45/70

(57) ABSTRACT

A method of for performing carbon neutralization in a communication network is provided. The method includes receiving a service task from a user equipment. The method also includes obtaining a carbon neutralization calculation parameter related to performing the received service task. The method further includes selecting, based on the obtained carbon neutralization calculation parameter, a target entity from a plurality of candidate targets at which the received service task can be performed. The method further includes sending the received service task to the selected target entity.

### CROSS REFERENCE TO RELATED APPLICATIONS

The present application claims priority to U.S. Provisional Application No. 63/331,345, entitled “Enhanced Carbon Neutralized Handling”, filed on Apr. 15, 2022. The U.S. Provisional Application is incorporated herein by reference in its entirety.

### TECHNICAL FIELD

The present disclosure relates generally to a communication network. In particular, the disclosure relates to enhanced carbon neutralization operations in a communication network.

### BACKGROUND

The primary driver of climate change is the global warming effect caused by excessive emissions of carbon dioxide. Human activities, such as burning fossil fuels for electricity generation, have significantly increased carbon emissions over the past few decades. To effectively mitigate the impact of climate change, an important approach is to achieve carbon neutrality by compensating for carbon emissions through the acquisition of carbon offsets.

While carbon offsetting mechanisms can make great contributions in mitigating carbon emissions, they have limitations in effectively reducing overall emissions. Therefore, it is essential to prioritize reducing carbon emissions in the first place, rather than solely relying on the offsetting mechanisms. For the purposes of accelerating the decarbonization process and ensuring a sustainable future, it is desirable to explore ways to reduce carbon emissions from the source, so as to directly address the root cause of climate change.

### SUMMARY

Aspects of the disclosure provide a method for performing carbon neutralization in a communication network. The method includes receiving a service task from a user equipment. The method also includes obtaining a carbon neutralization calculation parameter related to performing the received service task. The method further includes selecting, based on the obtained carbon neutralization calculation parameter, a target entity from a plurality of candidate targets at which the received service task can be performed. The method further includes sending the received service task to the selected target entity.

Aspects of the disclosure provide an apparatus for performing carbon neutralization in a communication network. The apparatus includes circuitry configured to receive a service task from a user equipment, obtain a carbon neutralization calculation parameter related to performing of the received service task, select, based on the obtained carbon neutralization calculation parameter, a target entity from a plurality of candidate targets at which the received service task can be performed, and send the received service task to the selected target entity.

Aspects of the disclosure also provide a non-transitory computer-readable medium storing instructions. The instructions, when executed by a processor, can cause the processor to perform the above method for performing carbon neutralization in a communication network.

Note that this summary section does not specify every embodiment and/or incrementally novel aspect of the present disclosure or claimed invention. Instead, the summary only provides a preliminary discussion of different embodiments and corresponding points of novelty. For additional details and/or possible perspectives of the invention and embodiments, the reader is directed to the Detailed Description section and corresponding figures of the present disclosure as further discussed below.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows a flow chart of a non-limiting example of a process for implementing enhanced carbon neutralization in a communication network, at an application server level, in accordance with embodiments of the disclosure;

FIG. 2 shows a non-limiting example of a scenario where enhanced carbon neutralization is implemented in a communication network, at an application server level, in accordance with embodiments of the disclosure;

FIG. 3 shows a flow chart of a non-limiting example of a process for implementing enhanced carbon neutralization in a communication network, at a service entity level, in accordance with embodiments of the disclosure;

FIG. 4 shows a non-limiting example of a scenario where enhanced carbon neutralization is implemented in a communication network, at a service entity level, in accordance with embodiments of the disclosure;

FIG. 5 shows a non-limiting example of a scenario where enhanced carbon neutralization is implemented in a communication network, at an application server level, in accordance with embodiments of the disclosure;

FIG. 6 shows a non-limiting example of a scenario where enhanced carbon neutralization is implemented in a communication network, at an application server level, in accordance with embodiments of the disclosure;

FIG. 7 shows a non-limiting example of a scenario where enhanced carbon neutralization is implemented in a communication network, at an application server level, in accordance with embodiments of the disclosure; and

FIG. 8 shows a non-limiting example of a scenario where enhanced carbon neutralization is implemented in a communication network, at an application server level, in accordance with embodiments of the disclosure.

### DETAILED DESCRIPTION OF EMBODIMENTS

The following disclosure provides many different embodiments, or examples, for implementing different features of the provided subject matter. Specific examples of components and arrangements are described below to simplify the present disclosure. These are, of course, merely examples and are not intended to be limiting.

For example, the order of discussion of the different steps as described herein has been presented for the sake of clarity. In general, these steps can be performed in any suitable order. Additionally, although each of the different features, techniques, and configurations, etc., herein may be discussed in different places of this disclosure, it is intended that each of the concepts can be executed independently of each other or in combination with each other. Accordingly, the present disclosure can be embodied and viewed in many different ways.

Furthermore, as used herein, the words “a,” “an,” and the like generally carry a meaning of “one or more,” unless stated otherwise.

Typically, the communication network of a mobile communication system is composed of a variety of physical or logical entities or functions that work together to provide communication services to end users. For example, the communication network can include network entities, control functions, and service entities.

Network entities can be physical or logical components of the communication network that provide the underlying infrastructure for various network services. Examples of network entities include the radio access network (RAN), the remote radio unit (RRU), the core network (CN) entrance, the serving gateway (S-GW), and the packet data network gateway (P-GW), among others.

Control functions are responsible for the management and coordination of various resources, including the allocation of radio spectrum and network resources. In the context of carbon neutralization, control functions can include functions related to energy utilization and user experience, for example, to reduce carbon footprint and energy consumption while providing effective network operation. Other examples of control functions in the communication network are the mobility management function, the session management function, and the policy control function, etc.

Service entities are responsible for providing specific services to users. For example, the service entities in a 5G communication network can include the baseband unit (BBU) and the router. As other examples of service entities in a mobile communication system, the Home Location Register (HLR) can provide user data and mobility management services, and the Short Message Service Center (SMSC) can provide short message service (SMS) messaging services. In future 6G and updated communication networks, service entities may offer a wider range of services, including but not limited to, computing, rendering, and machine learning inference, among others.

A control function and a network entity can be collocated by physically locating the control function within the network entity. Similarly, a control function can be collocated with a service entity by integrating the control function as part of the software, hardware, and/or firmware of the service entity. Moreover, a service entity can also be provided as a specific service function within a network entity, or its software, hardware, and/or firmware can be integrated with those of a network entity to achieve collocation between service entities and network entities.

Outside the communication network, a plurality of application servers can interact with the communication network to access network resources and offer services to end users. These servers are responsible for providing specific services or applications to end users. Examples of the specific services or applications can include computing, video streaming, social networking, and gaming, etc. The application servers can be located in the cloud or on-premises, and can communicate with the communication network via standard interfaces and protocols.

To enable users to access a diverse array of services and applications on their user equipments (UEs), the UEs can connect to the communication network to send service requests and receive results. These service tasks can be executed by application servers coupled to the communication network, or by service entities within the communication network.

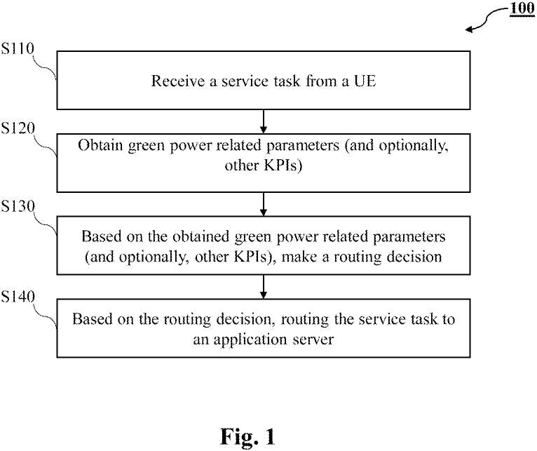

FIG. 1 shows a flow chart of a non-limiting example of a process 100 for implementing enhanced carbon neutralization in a communication network, at an application server level, in accordance with embodiments of the disclosure.

In step S110, a service task is received by the communication network from a UE. For instance, this service task can be performed by any one of multiple application servers linked to the communication network.

In step S120, green power related parameters related to performing of the service task can be obtained. For example, the green power related parameters can include current carbon intensity and/or power consumption of a particular application server, carbon intensity and/or power consumption for a particular application server to conduct the service task, etc. The green power related parameters can be monitored by the individual application servers and sent to the communication network. One skilled in the art can appreciate other possible approaches. For example, the green power related parameters can be collected by a third-party entity and fed to the communication network, or measured by a dedicated entity within the communication network.

Additionally, the green power related parameters can include carbon intensity and/or power consumption of other entities, such as network entities and service entities of the communication network, that contribute to the process of completing a service task by a specific application server. They can be collected by the entities themselves, or by another entity within or out of the communication network.

Optionally, other key performance indicator (KPI) related parameters can be obtained as well. For example, parameters such as the server loading and the queue length of a particular application server can be sent to the communication network. The KPI related parameters can be generated by the application servers, a third-party entity, or a dedicated entity in the communication network. KPI parameters related to components of the communication network that are potentially involved while an application server executes the service task can also be obtained.

In step S130, a routing decision can be made based on the obtained green power related parameters, and optionally, the obtained other KPI related parameters to determine at which application server the service task will be performed. For example, the routing decision can be made by minimizing a cost function as follows:

$$M i n \left({F}_{C} \left(C , P\right) + {F}_{Q} \left(Q\right) + {F}_{K} \left(K\right)\right) ; \text{or}$$

$$M i n \left(F \left(C , P , Q , K\right)\right)$$

wherein Fₓ represents a cost function, C denotes the carbon intensity of an application server, P denotes the power consumption of the application server, Q denotes the queue length of the application server, and K denotes other KPIs, e.g., the server loading of the application server, for example. By incorporating these parameters into the cost function, carbon emissions caused by the service task can be optimized, while allowing for flexible and efficient distribution of workload and network resources.

As an example, when a UE submits a computing task request, by taking into account the carbon intensity, power consumption, server loading, and queue length, etc., an application server can be identified to carry out the task, such that the resulting carbon footprint is lowest. This allows the computing task to be completed in an environmentally friendly and timely way.

Note that the cost functions are only non-limiting examples that can be applied to implement the idea of this disclosure. In fact, cost functions with more (or less) green power related parameters and KPI related parameters can be used.

In step S140, the service task is routed to the application server as determined in step S130. For example, IP address translation can be conducted to obtain the IP address of the determined application server. Then, the service task can be routed to the obtained IP address, so that the service task can be performed by the application server.

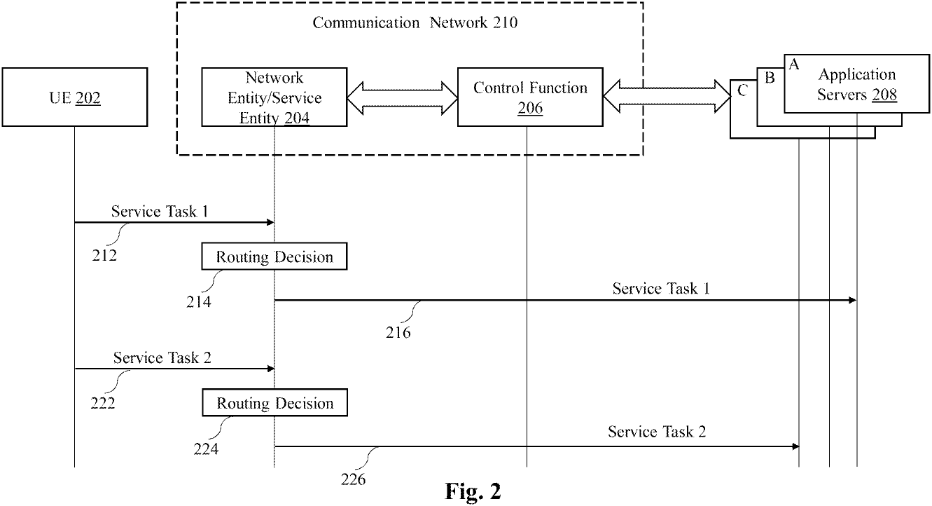

FIG. 2 shows a non-limiting example of a scenario where enhanced carbon neutralization is implemented in a communication network, at an application server level, in accordance with embodiments of the disclosure. It is appreciated that the numbers of components of the communication network 210, the UE 202, and the application servers 208 illustrated in FIG. 2 are not restrictive. Without departing from the scope of the disclosure, other numbers of the network entities, the service entities, the control functions, the UEs, and the application servers are feasible.

As shown in FIG. 2, at 212, the UE 202 sends a service task 1 to the communication network 210. Based on the green power related parameters, and optionally, the other KPI related parameters with respect to the application servers 208, for example, the control function 206 can make a routing decision 214 to decide at which application server the service task 1 will be performed. Based on the routing decision 214, the service task 1 can be routed at 216 to the determined application server, e.g., the application server A. Similarly, based on the green power related parameters, and optionally, the other KPI related parameters with respect to the application servers 208, the control function 206 can make a routing decision 224 for a service task 2 originating from the UE 202. Then, the service task 2 can be routed at 226 to a determined one of the application servers 208, for example, the application server C.

One skilled in the art may recognize that certain service tasks sent from the UE can be accomplished by the service entities within the communication network, without the participation of any application servers. Basic connectivity services, such as authentication and authorization, mobility management, and user data management, can be directly provided by the entities and functions within the communication network. As technology continues to advance, it is possible to envision that additional services, such as computation and inference, could also be executed directly by entities and functions in the communication network.

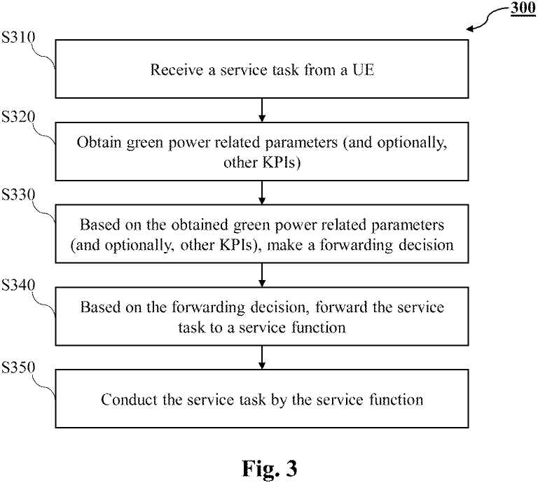

FIG. 3 shows a flow chart of a non-limiting example of a process for implementing enhanced carbon neutralization in a communication network, at a service entity level, in accordance with embodiments of the disclosure.

In step S310, a service task is received by the communication network from a UE. For instance, this service task can be performed by any one of multiple service entities of the communication network. In step S320, green power related parameters can be obtained. Optionally, other KPI related parameters can be obtained. These parameters can be related to the multiple service entities that can be assigned to perform the service task, and/or other entities/functions that can be involved in completion of the service task.

In step S330, a forwarding decision can be made, based on the obtained green power related parameters, and optionally, the obtained other KPI related parameters, so as to determine a proper service entity. Similar to that described with reference to FIG. 1, the forwarding decision can be made by minimizing a cost function considering the obtained parameters.

In step S340, the service task can be forwarded to the service entity as determined in step S330. In step 350, the service task can be performed by that service entity.

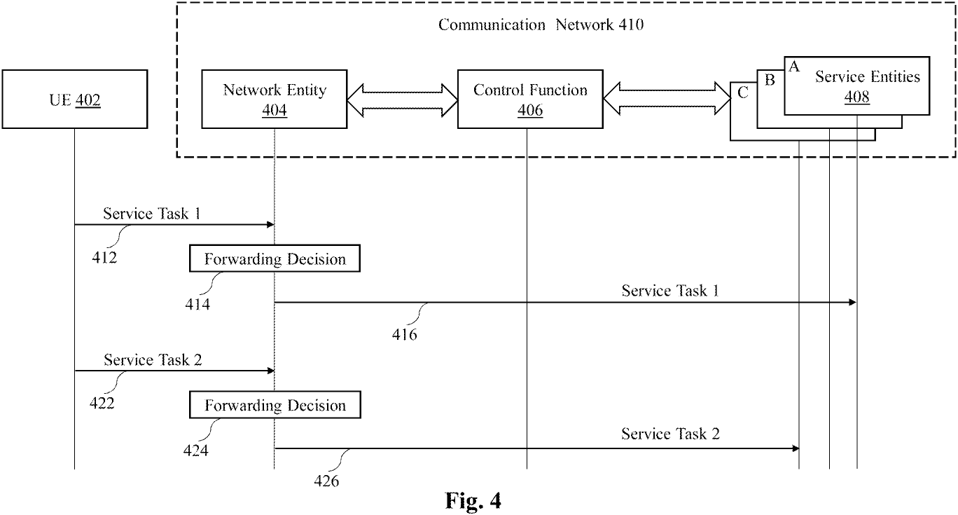

FIG. 4 shows a non-limiting example of a scenario where enhanced carbon neutralization is implemented in a communication network, at a service entity level, in accordance with embodiments of the disclosure. Although one UE 402, one network entity 404, one control function 406 and three service entities 408 are illustrated, this is not limiting as other numbers of components are possible.

At 412, the UE 402 sends a service task 1 to the communication network 410. Based on the green power related parameters, and optionally, the other KPI related parameters with respect to the service entities 408, for example, the control function 406 can make a forwarding decision 414 to decide at which service entity the service task 1 will be performed. Based on the forwarding decision 414, the service task 1 can be forwarded at 416 to the determined service entity, e.g., the service entity A. Similarly, based on the green power related parameters, and optionally, the other KPI related parameters with respect to the service entities 408, the control function 406 can make a forwarding decision 424 for a service task 2 originating from the UE 402. Then, the service task 2 can be forwarded at 426 to a determined one of the service entities 408, for example, the service entity C.

In some embodiments, the green power related parameters and the other KPI related parameters of the application servers (or the service entities) can be obtained through measurement. Additionally or alternatively, these parameters can be predicted using collected historical or statistical data by the application servers, entities within the communication network, or third-party entities. Machine learning (including but not limited to, Federated Learning, Reinforcement Learning, etc.) and/or big data analysis can be applied to the collected data to generate such predictions, for example.

Under some circumstances, despite having been sent to a particular application server, as part of an effort to reduce carbon footprint, a service task may not be executed immediately. For example, it may wait for the application server to transition from using “greyer” or more polluting energy sources, such as coal-fired power, to “greener” or cleaner energy sources, such as wind power or solar power. During this waiting period, updated parameters from measurements and/or predictions may become available to the communication network.

In accordance with some embodiments of this disclosure, prior to executing a service task on the determined application server, a new routing decision can be made based on updated green power related parameters, and optionally, updated KPI related parameters. If the newly determined application server differs from the originally determined one, the service task can be relocated to the new identified application server.

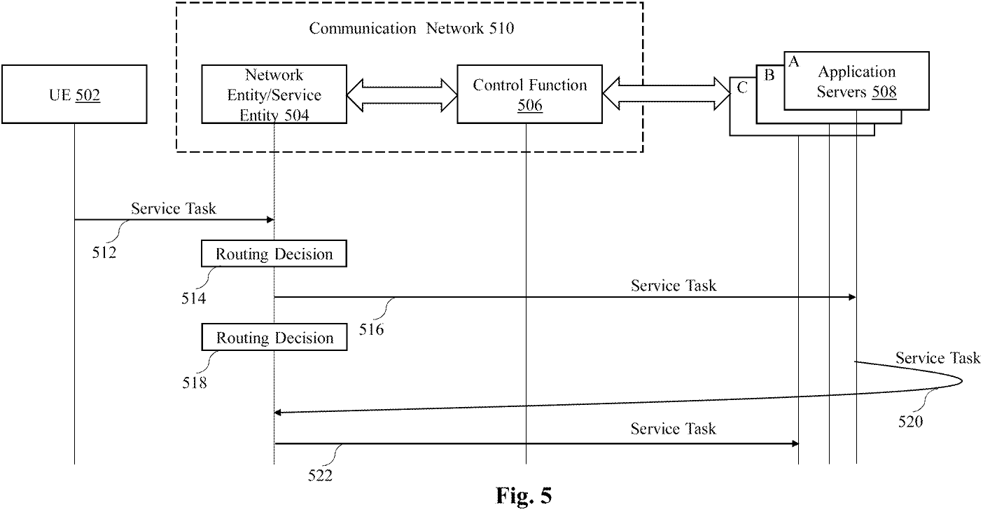

FIG. 5 shows a non-limiting example of a scenario where enhanced carbon neutralization is implemented in a communication network, at an application server level, in accordance with embodiments of the disclosure.

As shown in FIG. 5, at 512, the UE 502 sends a service task to the communication network 510. Based on the green power related parameters, and optionally, the other KPI related parameters with respect to the application servers 508, for example, the control function 506 can make a routing decision 514 to decide at which application server the service task will be performed. Based on the routing decision 514, the service task can be routed at 516 to the determined application server, for example, the application server A.

Before the service task is conducted by the application server A, updated green power related parameters (and optionally, updated other KPI related parameters) can become available. For example, a new prediction of the green power related parameters can be obtained. Based on the updated parameters, a new routing decision can be made at 518. When the new routing decision 518 is distinct from the original routing decision 514, the service task can be returned at 520 by the application server A to the communication network. Then, the service task can be resent at 522 to a different application server as determined in the new routing decision, for example, the application server C.

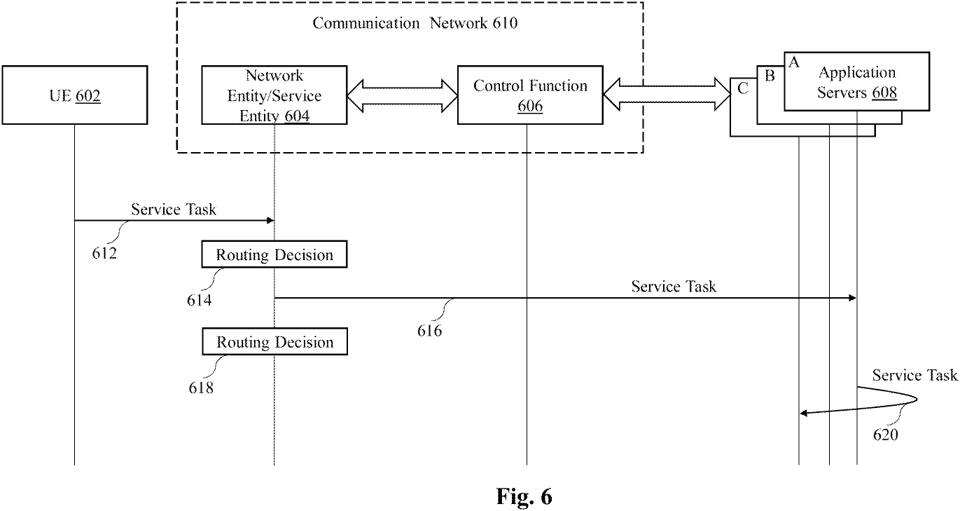

FIG. 6 shows a non-limiting example of a scenario where enhanced carbon neutralization is implemented in a communication network, at an application server level, in accordance with embodiments of the disclosure. In contrast to the scenario depicted in FIG. 5, in the scenario shown in FIG. 6, the control function 606 can request the originally determined application server, the application server A, to redirect the service task at 620 to the new application server determined in the new routing decision 618, e.g., the application server C, while all other aspects remain the same.

In accordance with some embodiments of this disclosure, the UE can be able to provide its own green power related parameters and/or KPI related parameters to the communication network, although this is not shown in the drawings. For example, the green power related parameters can include information on whether the UE is charging over a green power grid, carbon intensity of the current power grid, etc. The KPI related parameters can include but are not limited to, timing requirements of the service task (e.g., the deadline of completing the service task), configuration and specification of the UE (e.g., a high weight/performance indication, a low power mode indication), some measured parameters of the UE (e.g., a thermal indication, a battery level indication, a connectivity condition such as throughput). The cost function utilized to make the routing/forwarding decision can incorporate these parameters from the UE. This can facilitate components of the communication network, particularly, the control functions, to make decisions, so as to meet the quality and performance requirements specified by the UE and enhance the user experience.

In certain embodiments of the disclosure, the service task received from the UE can be divided into subtasks to be shared by multiple parties. As an example, if a UE is charging over a green power grid and the application servers are using energy from greyer power sources, more subtasks divided from a rendering task can be taken by the UE to suppress the carbon footprint. As another example, a part of a machine learning inference task can be executed by the UE, while other parts can be handled by various application servers (or service functions).

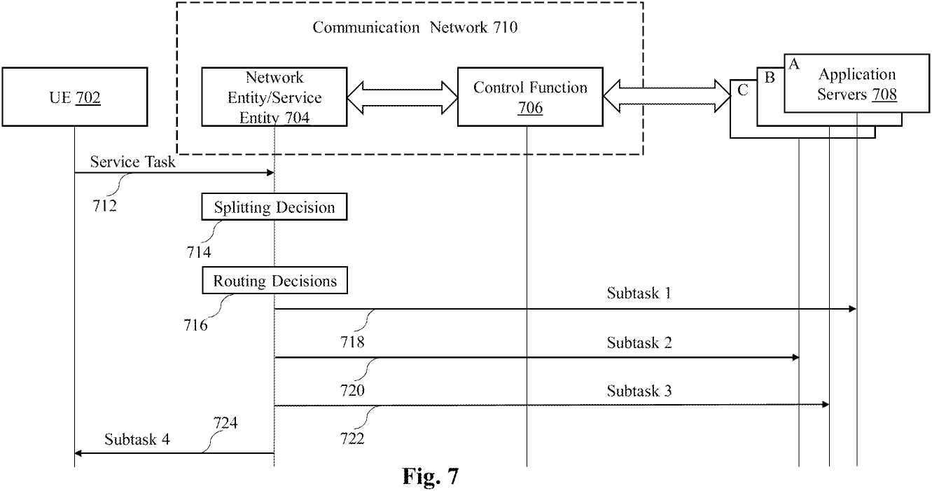

FIG. 7 shows a non-limiting example of a scenario where enhanced carbon neutralization is implemented in a communication network, at an application server level, in accordance with embodiments of the disclosure.

At 712, the UE 702 sends a service task to the communication network 710. Based on the green power related parameters, and optionally, the other KPI related parameters with respect to the application servers 708, relevant components of the communication network 710, and/or the UE 702, the service task can be split, at 714, into multiple subtasks, for example, subtasks 1, 2, 3, and 4. Routing decisions can be made at 716 for the individual subtasks. Then, each of the subtasks 1-4 can be routed to a corresponding one of the applications servers 708 and the UE 702, as shown at 718, 720, 722, and 724.

One skilled in the art can realize that it is possible to further divide the subtasks. Additionally, before the subtasks are executed, if certain criteria are met (for example, when updated parameters are obtained), some subtasks may be combined. After that, a routing decision can be made for the merged subtask, in order to determine which application server will be responsible for its execution. Finally, the merged subtask can be routed to the designated application server.

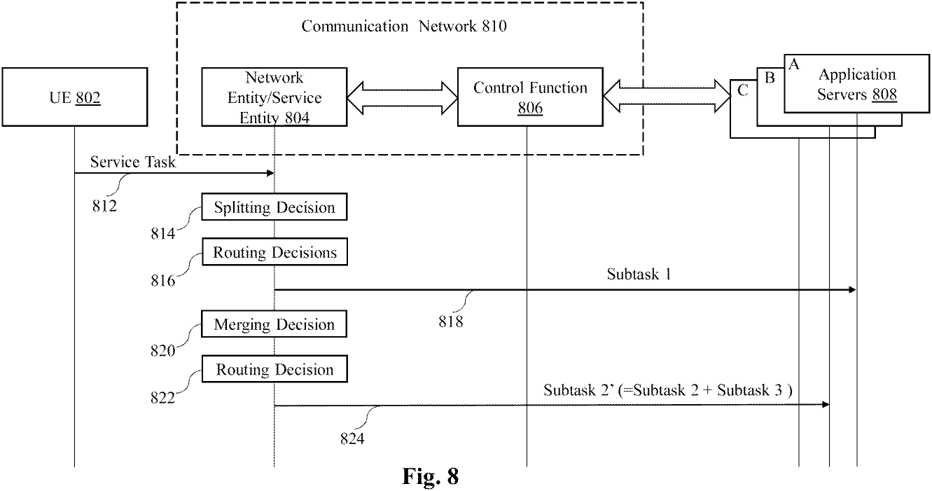

FIG. 8 shows a non-limiting example of a scenario where enhanced carbon neutralization is implemented in a communication network, at an application server level, in accordance with embodiments of the disclosure.

At 812, the UE 802 sends a service task to the communication network 810. Based on the green power related parameters, and optionally, the other KPI related parameters with respect to the application servers 808, relevant components of the communication network 810, and/or the UE 802, the service task can be split, at 814, into multiple subtasks, for example, subtasks 1, 2, and 3. Routing decisions can be made at 816 for the individual subtasks. Then, the subtask 1 can be routed at 818 to a corresponding one of the applications servers 808, for example, the application server A. As to the subtasks 2 and 3, based on updated green power related parameters, KPI related parameters and/or parameters from the UE, a merging decision is made at 820 to generate a merged subtask 2′. Based on the routing decision 822 made for the merged subtask 2′, it can be routed to a certain one of the application servers 808, for example, the application server B.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

What is claimed is:

1. A method for performing carbon neutralization in a communication network, comprising:
receiving a service task from a user equipment;
obtaining a carbon neutralization calculation parameter related to performing the received service task;
selecting, based on the obtained carbon neutralization calculation parameter, a target entity from a plurality of candidate targets at which the received service task can be performed; and
sending the received service task to the selected target entity.

2. The method of claim 1, wherein the selecting step further comprises:
determining, using a cost function includes a cost based on the obtained carbon neutralization calculation parameter, the selected target entity, such that the cost function with respect to the selected target entity is minimized.

3. The method of claim 1, wherein the obtained carbon neutralization calculation parameter includes a green power related parameter with respect to each of the plurality of candidate targets.

4. The method of claim 3, wherein the obtained carbon neutralization calculation parameter further includes a KPI related parameter with respect to each of the plurality of candidate targets.

5. The method of claim 3, wherein the obtained carbon neutralization calculation parameter further includes a user equipment related parameter received from the user equipment.

6. The method of claim 1, wherein
the plurality of candidate targets are a plurality of candidate application servers coupled to the communication network,
the selecting step further comprises selecting, from the plurality of candidate application servers, an application server, as the selected target entity, and
the sending step further comprises routing the received service task to the selected application server.

7. The method of claim 6, wherein the routing step further comprises:
performing IP address translation to derive an IP address of the selected application server; and
routing, based on the derived IP address, the received service task to the selected application server.

8. The method of claim 1, wherein
the plurality of candidate targets are a plurality of candidate service entities in the communication network,
the selecting step further comprises selecting, from the plurality of candidate service entities, a service entity, as the selected target entity, and
the sending step further comprises forwarding the received service task to the selected service entity.

9. The method of claim 1, further comprising:
obtaining an updated carbon neutralization calculation parameter;
reselecting, based on the updated carbon neutralization calculation parameter, an updated target entity; and
relocating, when the updated target entity is different from the originally selected target entity, the received service task to the updated target entity.

10. The method of claim 9, wherein the relocating step further comprises:
resending, upon the originally sent service task being returned by the originally selected target entity, the returned service task to the updated target entity, or
requesting the originally selected target entity to forward the originally sent service task to the updated target entity.

11. The method of claim 1, further comprising splitting, based on the obtained carbon neutralization calculation parameter, the received service task into a number of subtasks, wherein
the selecting step further comprises selecting, based on the obtained carbon neutralization calculation parameter, a target entity from the plurality of candidate targets and the user equipment, for each of the number of subtasks, and
the sending step further comprises sending, each of the number of subtasks to a correspondingly selected target entity.

12. The method of claim 11, further comprising:
obtaining an updated carbon neutralization calculation parameter; and
merging, based on the updated carbon neutralization calculation parameter, at least two of the number of subtasks, to generate a merged subtask, wherein
the selecting step further comprises selecting, based on the updated carbon neutralization calculation parameter, a collective target entity from the plurality of candidate targets and the user equipment, for the merged subtask, and
the sending step further comprises sending the merged subtask to the collective target entity.

13. The method of claim 3, wherein the green power related parameter includes carbon intensity and/or power consumption involved in performing the received service task at each of the plurality of candidate targets.

14. The method of claim 3, wherein the green power related parameter includes a parameter representing a currently measured status of each of the plurality of candidate targets and/or a plurality of communication network components to be involved in performing the received service task.

15. The method of claim 3, wherein the green power related parameter includes a parameter representing a predicted status of each of the plurality of candidate targets and/or a plurality of communication network components to be involved in performing the received service task.

16. The method of claim 15, wherein the green power related parameter is generated through machine learning on historic data with respect to each of the plurality of the candidate targets and/or the plurality of communication network components.

17. The method of claim 4, wherein the KPI related parameter includes a queue length and/or service loading of each of the plurality of candidate targets and/or a plurality of communication network components to be involved in performing of the received service task.

18. The method of claim 5, wherein the user equipment related parameter includes green power related information, configuration related information, working condition related information, and/or a timing requirement of the user equipment.

19. An apparatus for performing carbon neutralization in a communication network, comprising circuitry configured to:
receive a service task from a user equipment;
obtain a carbon neutralization calculation parameter related to performing the received service task;
select, based on the obtained carbon neutralization calculation parameter, a target entity from a plurality of candidate targets at which the received service task can be performed; and
send the received service task to the selected target entity.

20. A non-transitory computer readable medium including computer readable instructions, which when executed by at least one processor, cause the at least one processor to perform a method for performing carbon neutralization in a communication network, the method comprising:
receiving a service task from a user equipment;
obtaining a carbon neutralization calculation parameter related to performing the received service task;
selecting, based on the obtained carbon neutralization calculation parameter, a target entity from a plurality of candidate targets at which the received service task can be performed; and
sending the received service task to the selected target entity.
